(19) United States
(12) Patent Application Publication
(10) Pub. No.: US 2020/0104952 A1
(43) Pub. Date: Apr. 2, 2020

(54) LEAD GENERATOR USING MESSAGING CHATBOT

(71) Applicant: Opendoor Labs Inc., San Francisco, CA (US)

(72) Inventors: Sophia Randhawa, Belmont, CA (US); Kevin K. Teh, San Francisco, CA (US)

(21) Appl. No.: 16/149,566

(22) Filed: Oct. 2, 2018

(51) Int. Cl. G06Q 50/16; H04L 12/58; G06Q 30/02

(52) U.S. Cl. CPC G06Q 50/16; H04L 51/046; G06Q 30/0283; H04L 51/02

(57) ABSTRACT

Systems and methods for facilitating a lead generation messaging session is provided. In example embodiments, a networked system establishes a messaging session between with a user device of a user. The networked system requests submission of an address via the messaging session and receives the address from the user device via the messaging session. The address received via the messaging session is verified by the networked system. Based on the verified address, the networked system generates a report for the verified address. The report includes an estimated value for the verified address. The networked system causes presentation of a user interface illustrating the generated report.

### TECHNICAL FIELD

The subject matter disclosed herein generally relates to special-purpose machines for facilitating a messaging session, and to the technologies by which such special-purpose machines become improved compared to other machines that facilitate messaging sessions. Specifically, the present disclosure addresses systems and methods to facilitating a messaging session using a chatbot for lead generation.

### BACKGROUND

Conventionally, some lead generation systems provide written information to users and request the user to call a given phone number or access a website to obtain more information. Typically, users are not inclined to call unless they intend to proceed with whatever the lead generation system is offering. Additionally, accessing a website can be a cumbersome and time-consuming method to engage with the lead generation system. The uniform resource link (URL) must be entered correctly. Then the user may be required to navigate the site to obtain information.

### BRIEF DESCRIPTION OF THE DRAWINGS

Some embodiments are illustrated by way of example and not limitation in the figures of the accompanying drawings.

FIG. 1 is a diagram illustrating a network environment suitable for facilitating a lead generation messaging session, according to some example embodiments.

FIG. 2 is a block diagram illustrating components of a networked system, according to some example embodiments.

FIG. 3 is a block diagram illustrating components of a report generator, according to some example embodiments.

FIG. 4 is a flowchart illustrating operations of a method for facilitating the lead generation messaging session, according to some example embodiments.

FIG. 5 is a flowchart illustrating operations of a method for verifying an address from a user, according to some example embodiments.

FIG. 6 is a flowchart illustrating operations of a method for providing a report based on the address, according to some example embodiments.

FIG. 7 is a flowchart illustrating operations of a method for completing an offer flow using the lead generation messaging session, according to some example embodiments.

FIG. 8 illustrates an example written invitation to utilize a lead generation messaging session facilitated by the networked system.

FIG. 9 is an example screenshot of a lead generation messaging session between the networked system and a user;

FIG. 10 is an example screenshot of a lead generation messaging session requiring an address correction;

FIG. 11 is an example screenshot of a lead generation messaging session requiring additional address correction via a website;

FIG. 12 is an example user interface illustrating a report;

FIG. 13A and FIG. 13B are example screenshots of a messaging session for further information from the networked system;

FIG. 14 is a block diagram illustrating components of a machine, according to some example embodiments, able to read instructions from a machine-readable medium and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The present disclosure provides technical solutions for facilitating a lead generation messaging session. In example embodiments, a networked system establishes a messaging session with a user device of a user. The networked system requests submission of an address via the messaging session and receives the address from the user device via the messaging session. The address received via the messaging session is verified by the networked system. Based on the verified address, the networked system generates a report for the verified address. The report provides an estimated value for a property at the verified address. When requested, the networked system causes presentation of a user interface illustrating the generated report. In some embodiments, the messaging session continues whereby property attributes can be confirmed and/or an offer can be made.

Thus, example methods (e.g., algorithms) and example systems (e.g., special-purpose machines) are configured to improve a lead generation process using a messaging protocol that eliminates friction present in conventional systems that require more user interaction with various components of a lead generation system such as proactively accessing a website and navigating through the website to obtain information. Therefore, one or more of the methodologies described herein facilitate solving the technical problem of lead generation in a networked environment.

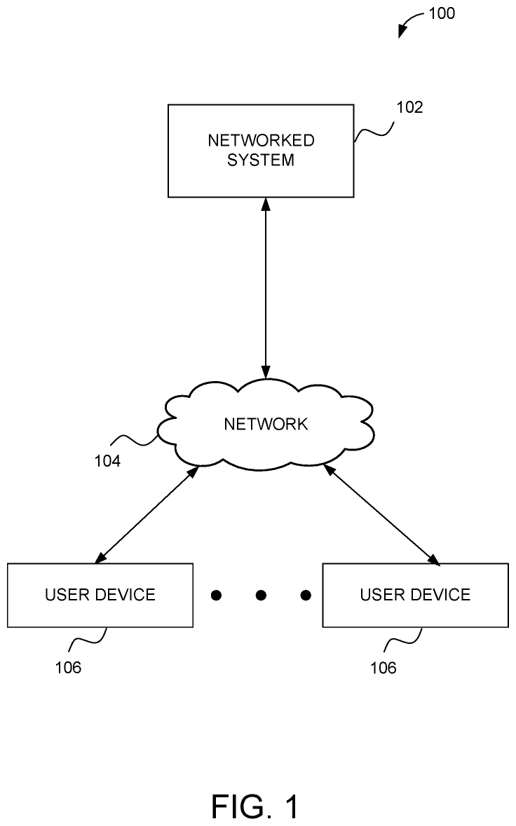

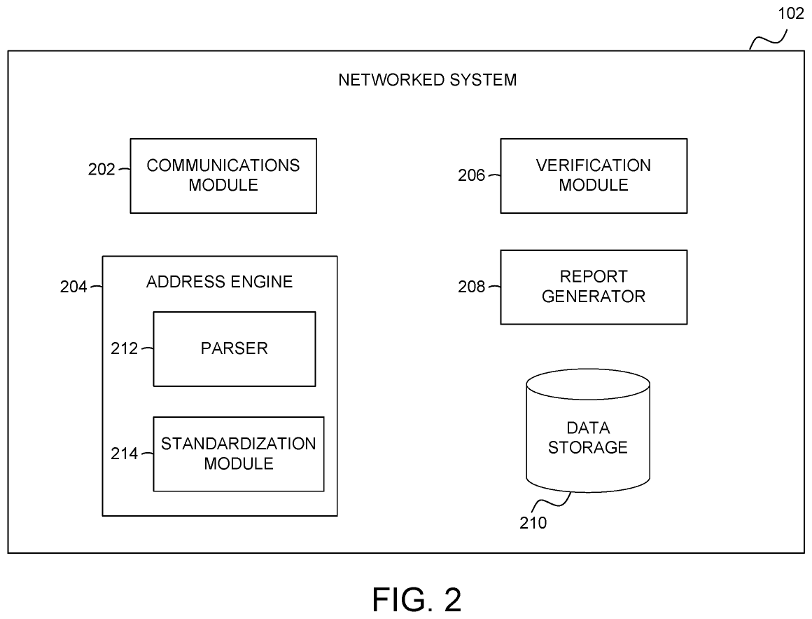

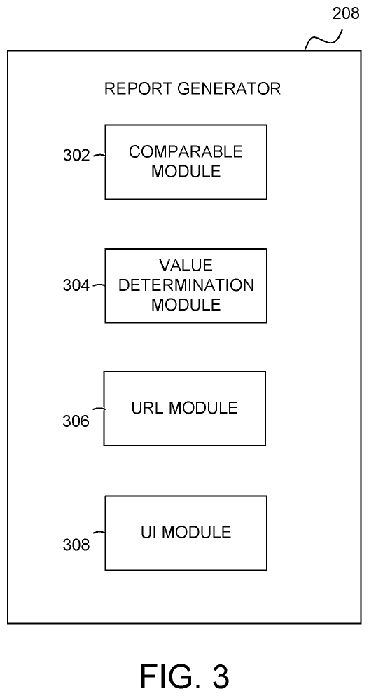

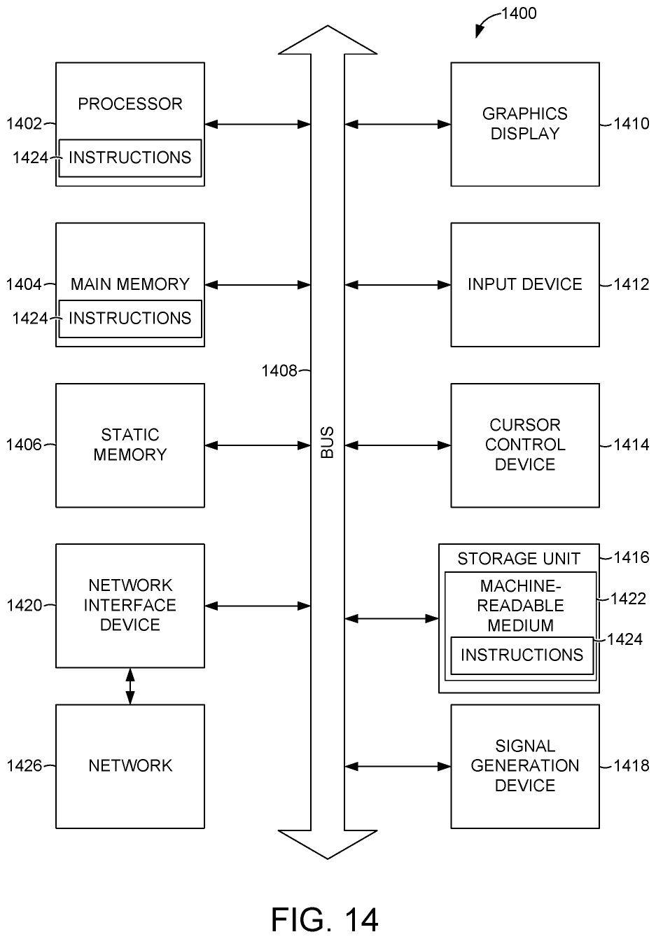

FIG. 1 is a diagram illustrating a network environment 100 suitable for facilitating a lead generation messaging session, according to some example embodiments. The network environment 100 includes a networked system 102 communicatively coupled via a network 104 to user devices 106. In example embodiments, the networked system 102 comprises components that facilitate a messaging session with the user devices 106 for lead generation. The components of the networked system 102 are described in more detail in connection with FIG. 2 and FIG. 3 and may be implemented in a computer system, as described below with respect to FIG. 14.

The components of FIG. 1 are communicatively coupled via the network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, a satellite network, a cable network, a broadcast network, another type of network, or a combination of two or more such networks. Any one or more portions of the network 104 may communicate information via a transmission or signal medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

In example embodiments, the user devices 106 are portable electronic devices such as smartphones, tablet devices, wearable computing devices (e.g., smartwatches), or similar devices. The user devices 106 each comprises one or more processors, memory, touch screen displays, wireless networking system (e.g., IEEE 802.11), cellular telephony support (e.g., LTE/GSM/UMTS/CDMA/HSDP A), and/or location determination capabilities. In some embodiments, the user devices 106 interact with the networked system 102 through a client application (not shown) stored thereon. The client application of the user devices 106 allow for exchange of information with the networked system 102 via a messaging interface. For example, the client application can comprise a messaging application that allows for communications via Short Message Service (SMS) or instant messaging. Alternatively, the messaging application comprises a social messaging application (e.g., WhatsApp, Facebook Messenger) or business messaging application (e.g., Skype). Further still, some embodiments can conduct at least a portion of a messaging session (e.g., check on status of offer, check schedule for inspection or signing) via a voice-activated mechanism, such as, Google Home or Alexa.

In example embodiments, a user operates the user device 106 that executes the messaging application to establish and maintain a messaging session with the networked system 102. During the messaging session, the user provides an address to the networked system 102. Using the address, the networked system 102 determines a value for a property at the address and generates a report that is provided to the user.

In example embodiments, any of the systems, machines, or devices (collectively referred to as “components”) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 14, and such a special-purpose computer may be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or devices illustrated in FIG. 1 may be combined into a single system or device, and the functions described herein for any single system or device may be subdivided among multiple systems or devices. Additionally, any number of user devices 106 may be embodied within the network environment 100. Furthermore, some components or functions of the network environment 100 may be combined or located elsewhere in the network environment 100. For example, some of the functions of the networked system 102 may be embodied within other systems or devices of the network environment 100. While only a single networked system 102 is shown, alternative embodiments may contemplate having more than one networked systems 102 to perform server operations discussed herein for the networked system 102.

FIG. 2 is a block diagram illustrating components of the networked system 102, according to some example embodiments. In various embodiments, the networked system 102 establishes and maintains a messaging session with the user device 106, identifies an address of interest, determines a value corresponding to the address, and generates a report based on the value. To enable these operations, the networked system 102 comprises a communications module 202, an address engine 204, a verification module 206, a report generator 208, and a data storage 210 all configured to communicate with each other (e.g., via a bus, shared memory, or a switch). The networked system 102 may also comprise other components (not shown) that are not pertinent to example embodiments. Furthermore, any one or more of the components (e.g., engines, interfaces, modules, storage) described herein may be implemented using hardware (e.g., a processor of a machine) or a combination of hardware and software. Moreover, any two or more of these components may be combined into a single component, and the functions described herein for a single component may be subdivided among multiple components.

The communication module 202 is configured to establish and maintain the messaging session with the user devices 106. As such, the communication module 202 receives a messaging request from the messaging application at the user device 102. For example, the user at the user device 106 sends a text to a text code or number associated with the networked system 102. In response to the messaging request, the communication module 202 establishes the messaging session. For example, the communication module 202 initiates the messaging session with a welcome message and asks the user to provide an address. The communication module 202 provides further messages to verify a standardized version of the address (also referred to herein as “verification request”), provide a personalized Uniform Resource Locator (URL) to access a customized report, ask questions about the property, and/or answer questions from the user. In addition to receiving an address from the user device 106, the communication module 202 also receives one or more responses to the verification request, answers to questions about the property, and questions from the user (e.g., when is the closing date, when is the inspection). At least some of the information received from the user devices 106 is stored to the data storage 210.

In example embodiments, when the communication module 202 establishes the messaging session, the communication module 202 also identifies and stores a device identifier for the user device 106. For example, the device identifier is a phone number for the user device 106 (e.g., a smartphone) or another unique identifier that can be used to contact the user device 106. The device identifier is stored, in association with information from the messaging session, in the data storage 210. The device identifier can be used by the networked system 102 to contact the user at a later time (e.g., to send a follow-up message).

In example embodiments, questions and answers to the user are accessed from the data storage 210. For example, if the user messages “when is my closing date,” the communication module 202 can automatically look up the answer (e.g., from a profile corresponding to the user) in the data storage 210. If the networked system 102 cannot answer a question from the user, then communication module 202 replies with a phone number for the user to call in accordance with one embodiment. Alternatively, the communication module 202 may connect the user with a live customer service agent (e.g., establish a chat session with the agent).

The address engine 204 processes address information. In example embodiments, a message (e.g., text) is received from the user device 106 that includes, for example, alphanumeric information that may represent an address. A parser 212 of the address engine 204 scans for a potential address (e.g., the alphanumeric information) in the message, and parses the potential address from the message. The parser 212 passes the potential address to a standardization module 214.

The standardization module 214 is configured to determine a standardized version of the address. As such, the standardization module 214 takes the potential address from the parser 212 and compares the address against an official address database (e.g., U.S. Postal Service database) to obtain a standardized version of the address. For example, if the user enters “116 New Montgomery San Francisco,” the standardization module 214 corrects the address to a standardized version of “116 New Montgomery St., San Francisco, Calif. 94105.” The standardized version of the address is then passed to the verification module 206.

The verification module 206 verifies whether the standardized version of the address is correct. In example embodiments, the verification module 206 provides, via the communications module 202 over the messaging session, the standardized version of the address and asks the user to verify the address. If the response message confirms that the standardized version of the address is correct, the standardized version of the address (herein referred to as a “verified address” after verification) is passed to the report generator 208. Alternatively, if the response message indicates that the standardized address is incorrect, the verification module 206 sends, via the communication module 202, a request message to the user to reenter the address. In some embodiments, a URL is provided to a website of the networked system 102 by the verification module 206 after a second verification request results in an incorrect address. The URL presents a webpage where the user can continue to enter their address.

The report generator 208 manages the determination of a value associated with the verified address and generation of a report that includes the value. The report generator will be discussed in more detail in connection with FIG. 3 below.

The data storage 210 is configured to store various data used by the networked system 102 to perform the value determination and report generation and provisioning. In example embodiments, the data is stored in, or associated with, a user profile corresponding to the device identifier or a user corresponding to the device identifier. The profile comprises messaging session information, the device identifier, and/or information regarding an offer or sales process (e.g., closing date, inspection date). The data storage 210 may also include questions that are accessed and presented (e.g., by the communications module 202) during a messaging session.

FIG. 3 is a block diagram illustrating components of the report generator 208, according to some example embodiments. In various embodiments, the report generator 208 generates a value associated with the verified address, generates a report (e.g., a user interface) that includes the value, and generates and provides a personalized URL that allows access to the generated report. To enable these operations, the report generator 208 comprises a comparable module 302, a value determination module 304, a URL module 306, and a user interface (UI) module 308 all configured to communicate with each other (e.g., via a bus, shared memory, or a switch). The report generator 208 may also comprise other components (not shown) that are not pertinent to example embodiments. Furthermore, any one or more of the components described herein may be implemented using hardware (e.g., a processor of a machine) or a combination of hardware and software. Moreover, any two or more of these components may be combined into a single component, and the functions described herein for a single component may be subdivided among multiple components.

The comparable module 302 determines comparable properties to that of the verified address. In example embodiments, the comparable module 302 accesses a database of properties (and their values) for an area associated with the verified address. For example, the comparable module 302 accesses a database of properties for a zip code of the verified address. The database includes properties listed for sale, in the process of being sold (e.g., pending), and/or have been sold. In some cases, the comparable module 302 has access to property attributes for the verified address which may include size of property, size of lot, conditions (e.g., number of bedrooms, number of bathrooms), year built, and so forth. The comparable module 302 then searches for other properties, typically that have been sold recently (e.g., within the last 6 months), to find a predetermined number of properties with similar property attributes, if known.

The value determination module 304 determines a value estimate (also referred to herein as “estimated value”) for the verified address. Accordingly, the value determination module 304 takes values of the comparable properties identified by the comparable module 302 and determines the value estimate for the verified address. In one embodiment, the value determination module 304 takes an average of the values of the comparable properties and makes an adjustment based on the property attributes for the verified address (e.g., increase value estimate if the property has a pool or larger lot; decrease value estimate if property has less bedrooms than comparable properties). If property attributes for the verified address are not known, then the value determination module 304 can, in some embodiments, take an average of the values of the comparable homes, an average of values properties for the zip code, or some other average based on comparable properties. In some embodiments, the value estimate for the verified address may be a particular value, while in other embodiments, the value estimate is provided as a range of values.

The URL module 306 generates a personalized URL to access a report for the verified address. The personalized URL is then transmitted by the communications module 302 via the messaging session to the user. The user can then use the URL, via their user device 106, to access the report that includes the value estimate determined by the value determination module 304.

The UI module 308 generates and provides access to the report that includes the value estimate for the verified address. In some embodiments, the report includes a value range for the value estimate. In some embodiments, the report also includes a selection (e.g., a button or icon) that allows the user to exchange further information with the networked system 102 in order to obtain an offer for the property at the verified address. The report can also include a selection that indicates that the value estimate appears to be off. When this selection is selected, the networked system 102 requests further information from the user including, for example, what the user believes the value estimate should be and property attributes that may affect the value estimate. In some embodiments, the user interface may be generated and stored to the data storage 210 such that when the URL is used to access the report, the user interface can be retrieved from the data storage 210. In other embodiments, the user interface is generated after the URL is used.

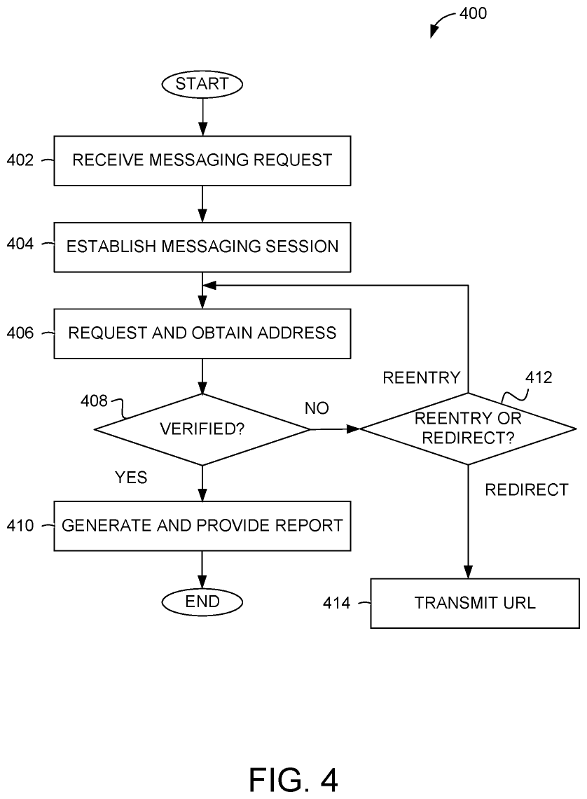

FIG. 4 is a flowchart illustrating operations of a method 400 for facilitating the lead generation messaging session, according to some example embodiments. Operations in the method 400 may be performed by the networked system 102, using components described above with respect to FIG. 2 and FIG. 3. Accordingly, the method 400 is described by way of example with reference to the networked system 102. However, it shall be appreciated that at least some of the operations of the method 400 may be deployed on various other hardware configurations or be performed by similar components residing elsewhere in the network environment 100. Therefore, the method 400 is not intended to be limited to the networked system 102.

In operation 402, a request to establish a messaging session is received by the communication module 202. In example embodiments, the request is sent from the messaging application at the user device 102 of the user. In one example, the user at the user device 106 sends a text to a text code or number associated with the networked system 102.

In operation 404, the message session is established by the communication module 202 in response to the request. In example embodiments, the communication module 202 acknowledges the messaging session by responding with a welcome message to the user. Additionally, when the communication module 202 establishes the messaging session, the communication module 202 also identifies and stores a device identifier for the user device 106. For example, the device identifier is a phone number for the user device 106 (e.g., a smartphone) or another unique identifier that can be used to contact the user device 106.

In operation 406, the communication module 202 requests the user to enter an address of interest via the messaging session. In response, a reply message is received from the user device 106 that information that represents the address.

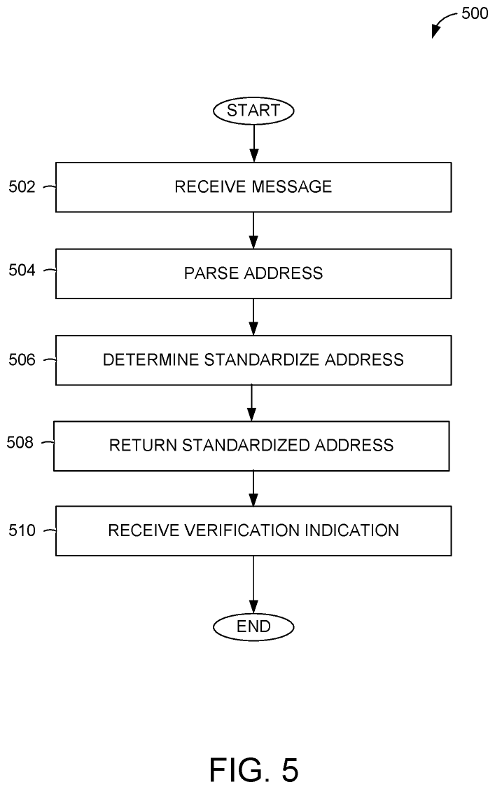

In operation 408, the networked system determines whether the standardized version of the address is correct. In example embodiments, the verification module 206 returns the standardized version of the address via the messaging session and asks the user to verify the address. Operations 406 and 408 will be discussed in more detail in connection with FIG. 5 below.

If the response message confirms that the standardized version of the address is correct, the standardized version of the address (herein referred to as a “verified address” after verification) is passed to the report generator 208 which generates and provides access to a report in operation 410. In example embodiments, the comparable module 302 accesses a database of values for properties in an area associated with the verified address. The comparable module 302 then searches for the properties, typically that have been sold recently (e.g., within the last 6 months), to find a predetermined number of properties with similar property attributes, if known, to that of the verified address. Subsequently, the value determination module 304 determines a value estimate for the verified address. Accordingly, the value determination module 304 uses values of the comparable properties identified by the comparable module 302 to determine the value estimate of the verified address. In one embodiment, the value determination module 304 takes an average of the values of the comparable properties and makes an adjustment based on the property attributes for the verified address, if known. If property attributes for the verified address are not known, then the value determination module 304 can, in some embodiments, simply take an average of the values of the comparable homes, an average of values properties for the zip code, or some other average based on comparable properties. Next, the URL module 306 generates a personalized URL that provides access to the report for the verified address. The personalized URL is transmitted by the communications module 302 via the messaging session to the user. Furthermore, the UI module 308 generates and provides access to the report that includes the value estimate for the verified address. In some embodiments, the user interface displaying the report may be generated and stored to the data storage 210 such that when the URL is used to access the report, the user interface can be retrieved from the data storage 210. In other embodiments, the user interface is generated after the URL is used.

Alternatively, if the response message indicates that the standardized address is incorrect in operation 408, the verification module 206 determines whether to send a message to the user to reenter the address or redirect the user to an alternative communication channel in operation 412. In some embodiments, a first failed attempt at verifying the address results in the networked system 102 asking the user to reenter the address. Thus, the method 400 returns to operation 408 to request reentry of the address. In some embodiments, a second failed attempt at verifying the address (e.g., after the reentry) causes the verification module 206 to send a URL to the user device 106 in operation 414. The URL provides access to a website of the networked system 102 where the user can further attempt to enter their address or otherwise exchange information with the networked system 102 to determine the correct address.

FIG. 5 is a flowchart illustrating operations of a method 500 (e.g., operations 406 and 408) for verifying an address from the user, according to some example embodiments. Operations in the method 500 may be performed by the networked system 102, using components described above with respect to FIG. 2. Accordingly, the method 500 is described by way of example with reference to the networked system 102. However, it shall be appreciated that at least some of the operations of the method 500 may be deployed on various other hardware configurations or be performed by similar components residing elsewhere in the network environment 100. Therefore, the method 500 is not intended to be limited to the networked system 102.

In operation 502, the networked system 102 (e.g., the communications module 202) receives a reply message that includes information representing the address. For example, the reply message can include alphanumeric information that represents the address.

In operation 504, the address is parsed from the reply message. In example embodiments, the parser 212 of the address engine 204 scans for a potential address (e.g., the alphanumeric information) in the reply message, and parses the potential address from the message. The parser 212 passes the potential address to a standardization module 214.

In operation 506, the standardization module 214 determines a standardized version of the address. In example embodiments, the standardization module 214 takes the potential address from the parser 212 and compares the address against an official address database to obtain a standardized version of the address. The standardized version of the address is then passed to the verification module 206.

In operation 508, the standardized address is returned by the verification module 206 in a return message. The return message also asks the user to verify whether the address is correct.

In operation 510, a verification indication is received by the networked system 102. In example embodiments, the verification module 206 examines the verification indication to determine whether the address is identified by the user as being correct. A correct address (e.g., verified address) triggers report generation, while an incorrect address triggers a reentry process or redirect to a website of the networked system 102.

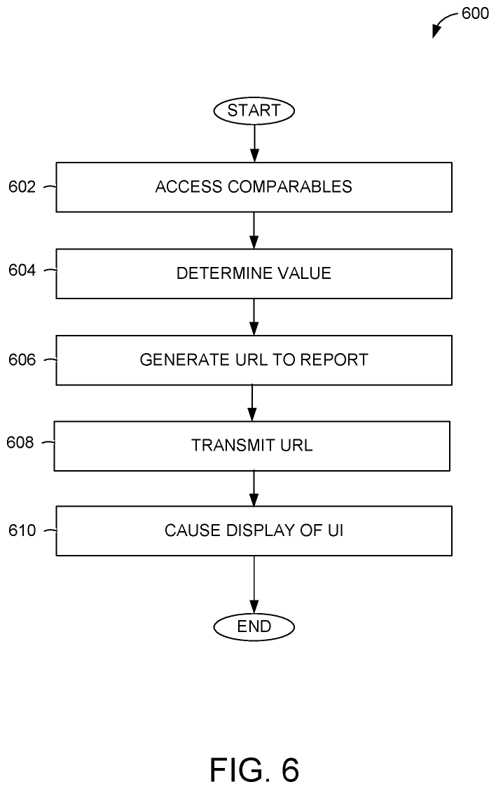

FIG. 6 is a flowchart illustrating operations of a method (e.g., operation 410) for providing a report based on the verified address, according to some example embodiments. Operations in the method may be performed by the report generator 208 of the networked system 102 using components described above with respect to FIG. 3. Accordingly, the method 600 is described by way of example with reference to the report generator 208. However, it shall be appreciated that at least some of the operations of the method 600 may be deployed on various other hardware configurations or be performed by similar components residing elsewhere in the network environment 100. Therefore, the method 600 is not intended to be limited to the report generator 208.

In operation 602, the comparable module 302 accesses a database of comparable properties (e.g., properties for an area associated with the verified address). For example, the comparable module 302 accesses a database of properties for a zip code of the verified address. The database includes properties listed for sale, in the process of being sold (e.g., pending), and/or have been sold. In some cases, the comparable module 302 has access to property attributes for the verified address which may include size of property, size of lot, conditions (e.g., number of bedrooms, number of bathrooms), year built, and so forth. The comparable module 302 then searches for other properties, typically that have been sold recently (e.g., within the last 6 months), to find a predetermined number of properties with similar property attributes, if known.

In operation 604, the value determination module 304 determines a value estimate for the verified address using values of the comparable properties identified by the comparable module 302. In one embodiment, the value determination module 304 takes an average of the values of the comparable properties and makes an adjustment based on the property attributes for the verified address (e.g., increase value estimate if the property has a pool or larger lot). If property attributes for the verified address are not known, then the value determination module 304 can, in some embodiments, take an average of the values of the comparable homes, an average of values properties for the zip code, or some other average based on comparable properties. In some embodiments, the value estimate for the verified address may be a particular value, while in other embodiments, the value estimate is provided as a range of values.

In operation 606, a personalized URL to a report corresponding to the verified address is generated. In example embodiments, the URL module 306 generates the personalized URL to access the report for the verified address. The personalized URL is then transmitted by the communications module 302 via the messaging session to the user in operation 608.

The user can then use the personalized URL, via their user device 106, to access the report that includes the value estimate. In operation 610, the user interface illustrating the report is caused to be displayed on the user device 106. In example embodiments, the UI module 308 generates and provides access to the user interface of the report that includes the value estimate for the verified address. In some embodiments, the user interface also includes a selection that allows the user to exchange further information with the networked system 102 in order to obtain an offer for the property at the verified address and a selection that indicates that the value estimate appears to be off In some embodiments, the user interface may be generated and stored to the data storage 210 such that when the URL is used to access the report, the user interface can be retrieved from the data storage 210. In other embodiments, the user interface is generated after the URL is used to access the report.

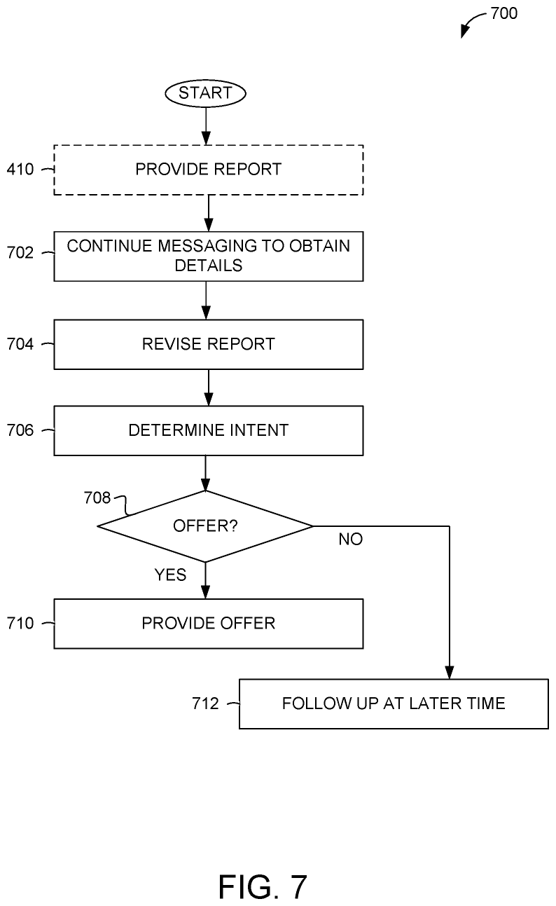

FIG. 7 is a flowchart illustrating operations of a method 700 for completing an offer flow using the lead generation messaging session, according to some example embodiments. The method 700 continues after the report is provided in operation 410. Operations in the method 700 may be performed by the networked system 102 using components described above with respect to FIG. 2. Accordingly, the method 700 is described by way of example with reference to the networked system 102. However, it shall be appreciated that at least some of the operations of the method 700 may be deployed on various other hardware configurations or be performed by similar components residing elsewhere in the network environment 100. Therefore, the method 700 is not intended to be limited to the networked system 102. Additionally, not all operations of the method 700 need to be executed.

In operation 702, the networked system 102 continues the messaging session to obtain further details about the property at the verified address. In example embodiments, the communication module 202 asks questions about the property. For example, the communication module 202 can ask about or verify various property attributes (e.g., how many bedrooms and bathrooms does the property have, what the square footage is, how large the lot is). The answers received via the messaging session can be stored to the profile in the data storage 210.

Using the answers, the report generator 208 revises the report in operation 704. As such, the comparable module 302 updates the comparable properties used to determine the value estimate by finding properties that closely match the additional property attributes obtained in operation 702. The value determination module 304 then determines a value estimate for the verified address using the values of the updated comparable properties. The UI module 308 updates the report with the new value and, in some cases, information indicating the updated property attributes. Because the personalized URL is specific to the user and the verified address, the same URL can be used to provide access to the revised report (e.g., the updated user interface illustrating the report).

In operation 706, an intent of the user is determined. The intent of the user is with respect to whether the user intends to sell their property at the verified address. The networked system 102 gauges how interested the person is based on a timeline. In one embodiment, the networked system 102 asks the user, via the messaging session, when the user plans on moving.

Based in the intent, a determination is made in operation 708 as to whether an offer should be made by the networked system 102 for the sale of the property. Thus, if the user indicates that they intend to move relatively soon (e.g., within the next month or two), then the networked system 102 generates and provides an offer in operation 710. In example embodiments, the offer is based on the estimated value. However, if the intent is low (e.g., the user does not plan on moving or plan on moving within the next few months; the user stops messaging via the messaging session), the networked system 102 follows up at a later time (e.g., in a few months). Because the device identifier is stored in the profile, the networked system 102 can reinitiate a messaging session at the later time to inquire whether the user's intent has changed or otherwise follow up with other information.

While example embodiments are discussed above with respect to accessing a value estimate and selling the property at the verified address via a messaging session, alternative embodiments contemplate buying a property at a verified address using a messaging session. In these embodiments, the messaging session would include the networked system 102 asking the user what area or address the user is interested in and/or property attributes (e.g., number of bedrooms and bathrooms). Using the information in the response, the report generator 208 finds comparable properties that are for sale. In some cases, the report generator 208 also determines a value estimate for the comparable properties. In some embodiments, the report generator 208 generates a report with one or more listings that most closely match the user's requirements and provides a corresponding URL to access the report. In other embodiments, the report generate provides URLs of the listings via the messaging session. The networked system 102 further asks, via the messaging session, whether the user would like to schedule a time to view any of the listings. Further operations (e.g., schedule inspections, schedule contract signing) to complete a purchase of a property can be initiated via follow up messaging sessions.

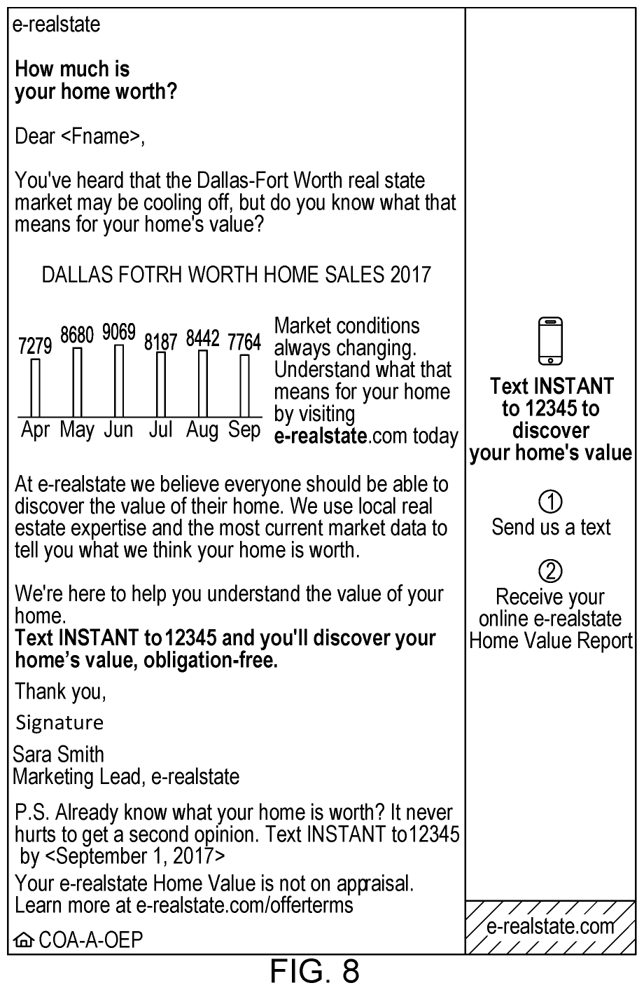

FIG. 8 illustrates an example written invitation to utilize a lead generation messaging session facilitated by the networked system 102. The invitation may be a postcard or letter mailed to a user. Alternatively, the invitation can be a digital invitation (e.g., sent via e-mail). The invitation includes a text code or number associated with the networked system 102 (e.g., 58028) that is used to request the messaging session with the networked system 102.

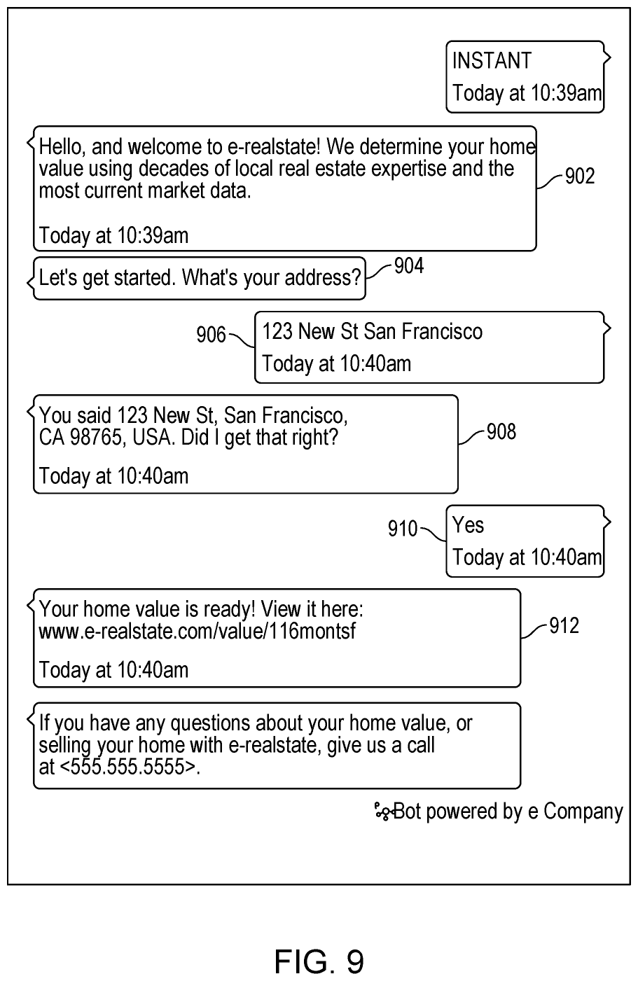

FIG. 9 is an example screenshot of a lead generation messaging session between the networked system 102 and the user that is shown on a display of the user device 106. As illustrated, the messaging session starts with a welcome message 902 and a request for an address message 904. A reply message 906 containing address information is sent by the user. The address information is parsed from the reply message 906 to obtain the address. The verification module 206 returns a verification message 908 requesting the user to confirm whether a standardized version of the address is correct. In the present example, the address is correct as indicated by a reply 910. As such, the networked system 102 generates the report that includes the estimated value for the verified address, generates a personalized URL, and generates a user interface that displays the report (or displays the information from the report). The URL is returned in a message 912. Additionally, other contact information (e.g., phone number) can be provided should the user want to talk with a live agent.

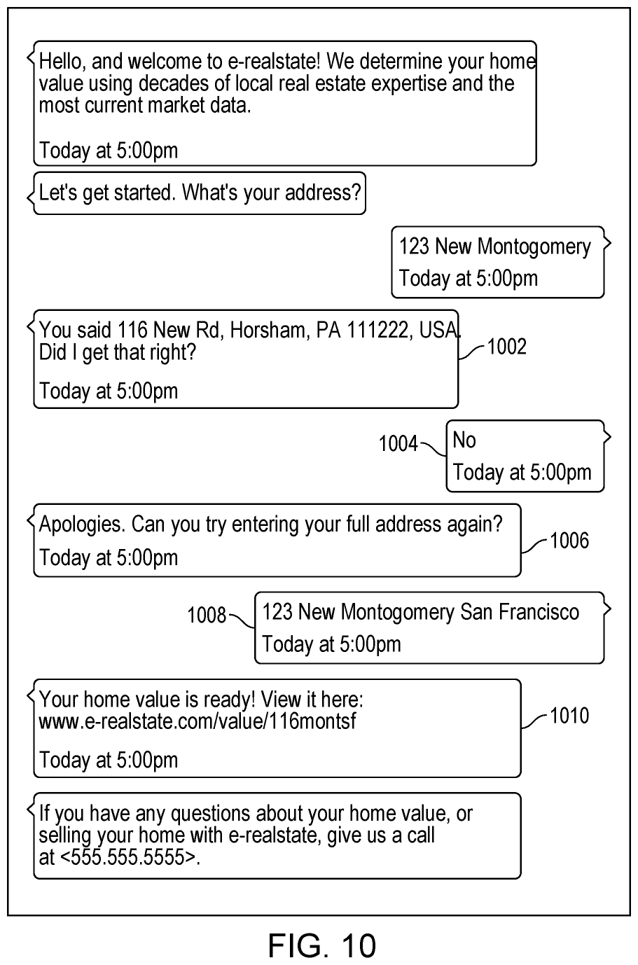

FIG. 10 is an example screenshot of a lead generation messaging session requiring an address correction. In the present example, a verification message 1002 has an incorrect address. Therefore, the user returns a reply 1004 that the address is incorrect. In response, the networked system 102 requests the user to reenter the address again in message 1006. The user provides the reentered address in message 1008. In some embodiments, the networked system 102 may send another verification message at this time to ensure that the address is correct. Once the address is verified, the personalized URL is returned in message 1010.

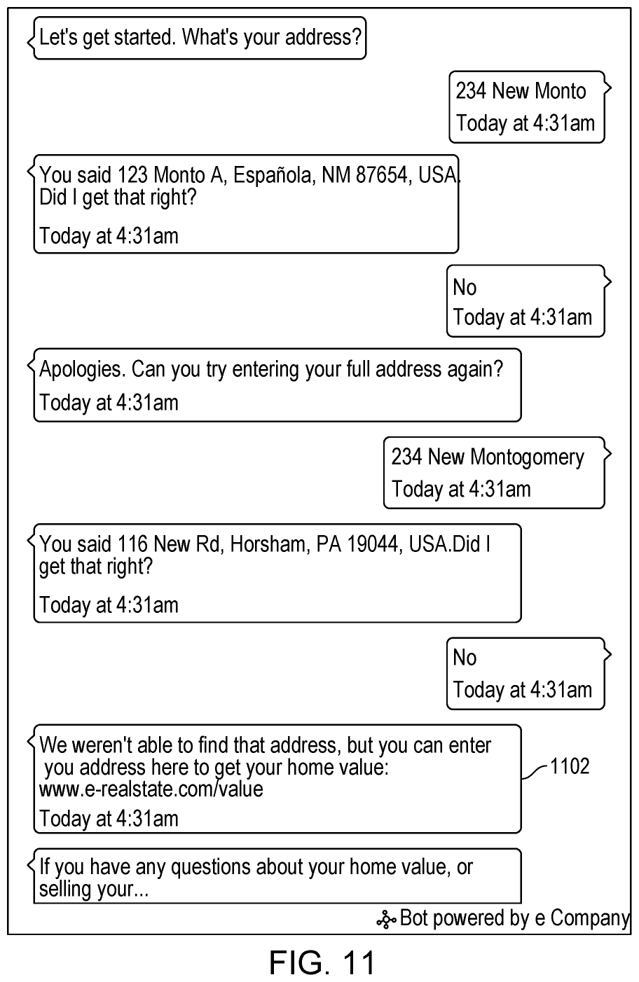

FIG. 11 is an example screenshot of a lead generation messaging session requiring additional address correction via a website. In this example, the first and second attempt at obtaining the address via the messaging session resulted in an incorrect address. As such, the networked system 102 indicates that the address cannot be found in message 1102. Instead, the user device 102 is redirected (e.g., via a URL), in the message 1102, to a webpage where the user can continue to try to enter and verify their address and obtain a value estimate.

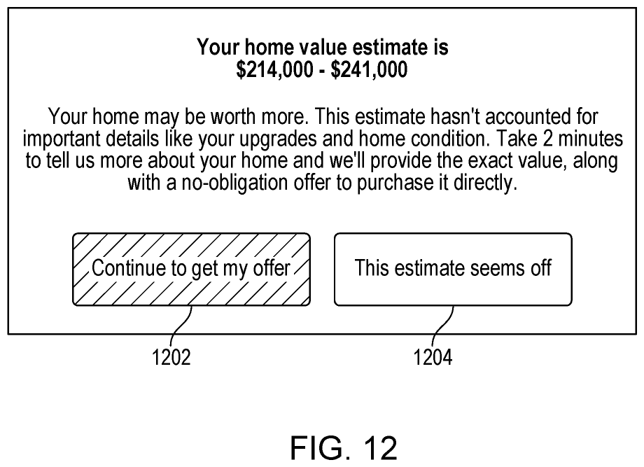

FIG. 12 is an example user interface illustrating a report (or information from the report). In the present example, the report indicates a value estimate range for the verified address. The report also includes a selection 1202 that allows the user to exchange further information with the networked system 102 in order to obtain an offer for the property at the verified address. In some cases, the report is generated without knowing some property attributes of the verified address. Thus, the report includes a selection 1204 to refine the value estimate (e.g., a selection that indicates that the value estimate appears to be off). When the selection 1204 is selected, the networked system 102 requests further information from the user including, for example, what the user believes the value estimate should be and property attributes that may affect the value estimate.

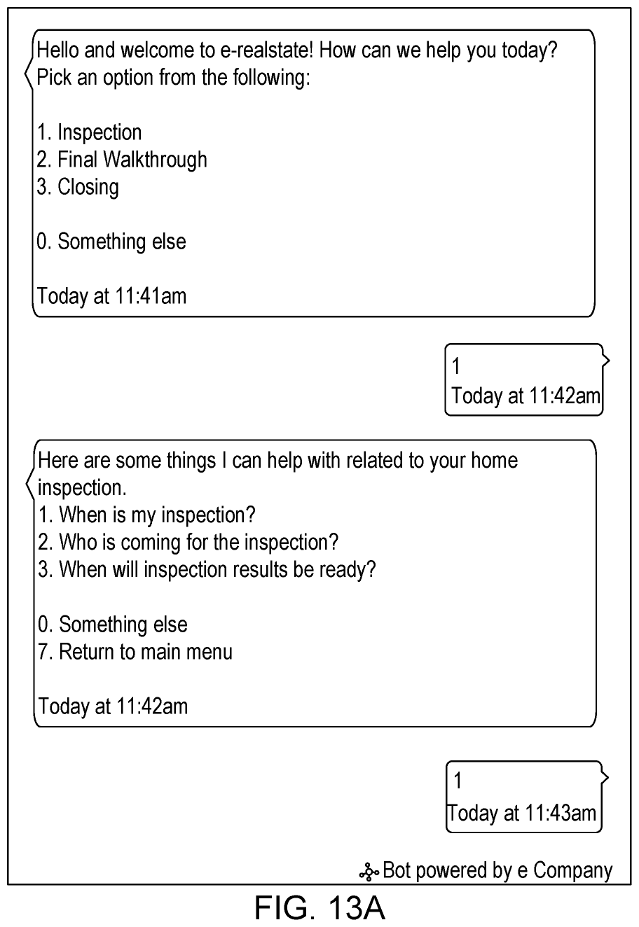

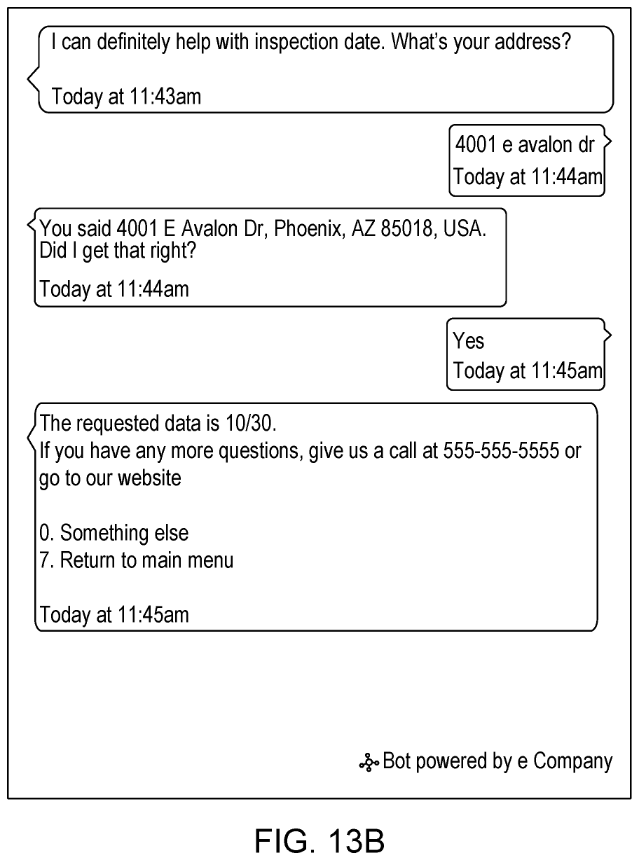

Further operations can occur via the messaging session (e.g., during the initial messaging session or in a later session) to complete the transaction, schedule inspections, schedule contract signing, and so forth. For example, FIG. 13A and FIG. 13B are example screenshot of a messaging session for further information from the networked system 102. In the example of FIG. 13A, a menu of options is provided from which the user can select an option to obtain further information. In the present example, the user selects “inspection,” which then causes a display of options within the inspection category. Here the user selected for information regarding the inspection date. Referring to FIG. 13B, the networked systems asks for the address and verifies the address. However in other embodiments, the networked system already has this information (e.g., from the user profile, continuation of messaging session with previously verified address), and the verification in the inspection category is not necessary. Once the address is known, the networked system 102 looks up the information and returns it in the messaging session.

FIG. 14 illustrates components of a machine 1400, according to some example embodiments, that is able to read instructions from a machine-readable medium (e.g., a machine-readable storage device, a non-transitory machine-readable storage medium, a computer-readable storage medium, or any suitable combination thereof) and perform any one or more of the methodologies discussed herein. Specifically, FIG. 14 shows a diagrammatic representation of the machine 1400 in the example form of a computer device (e.g., a computer) and within which instructions 1424 (e.g., software, a program, an application, an applet, an app, or other executable code) for causing the machine 1400 to perform any one or more of the methodologies discussed herein may be executed, in whole or in part.

For example, the instructions 1424 may cause the machine 1400 to execute the flow diagrams of FIGS. 5-7. In one embodiment, the instructions 1424 can transform the general, non-programmed machine 1400 into a particular machine (e.g., specially configured machine) programmed to carry out the described and illustrated functions in the manner described.

In alternative embodiments, the machine 1400 operates as a standalone device or may be connected (e.g., networked) to other machines. In a networked deployment, the machine 1400 may operate in the capacity of a server machine or a client machine in a server-client network environment, or as a peer machine in a peer-to-peer (or distributed) network environment. The machine 1400 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1424 (sequentially or otherwise) that specify actions to be taken by that machine. Further, while only a single machine is illustrated, the term “machine” shall also be taken to include a collection of machines that individually or jointly execute the instructions 1424 to perform any one or more of the methodologies discussed herein.

The machine 1400 includes a processor 1402 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1404, and a static memory 1406, which are configured to communicate with each other via a bus 1408. The processor 1402 may contain microcircuits that are configurable, temporarily or permanently, by some or all of the instructions 1424 such that the processor 1402 is configurable to perform any one or more of the methodologies described herein, in whole or in part. For example, a set of one or more microcircuits of the processor 1402 may be configurable to execute one or more modules (e.g., software modules) described herein.

The machine 1400 may further include a graphics display 1410 (e.g., a plasma display panel (PDP), a light emitting diode (LED) display, a liquid crystal display (LCD), a projector, or a cathode ray tube (CRT), or any other display capable of displaying graphics or video). The machine 1400 may also include an alphanumeric input device 1412 (e.g., a keyboard), a cursor control device 1414 (e.g., a mouse, a touchpad, a trackball, a joystick, a motion sensor, or other pointing instrument), a storage unit 1416, a signal generation device 1418 (e.g., a sound card, an amplifier, a speaker, a headphone jack, or any suitable combination thereof), and a network interface device 1420.

The storage unit 1416 includes a machine-readable medium 1422 (e.g., a tangible machine-readable storage medium) on which is stored the instructions 1424 (e.g., software) embodying any one or more of the methodologies or functions described herein. The instructions 1424 may also reside, completely or at least partially, within the main memory 1404, within the processor 1402 (e.g., within the processor's cache memory), or both, before or during execution thereof by the machine 1400. Accordingly, the main memory 1404 and the processor 1402 may be considered as machine-readable media (e.g., tangible and non-transitory machine-readable media). The instructions 1424 may be transmitted or received over a network 1426 via the network interface device 1420.

In some example embodiments, the machine 1400 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (i.e., 1404, 1406, and/or memory of the processor(s) 1402) and/or storage unit 1416 may store one or more sets of instructions and data structures (e.g., software) 1424 embodying or utilized by any one or more of the methodologies or functions described herein. These instructions, when executed by processor(s) 1402 cause various operations to implement the disclosed embodiments.

As used herein, the terms “machine-storage medium,” “device-storage medium,” “computer-storage medium” (referred to collectively as “machine-storage medium 1422”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 1422 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 1422 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 1424 may further be transmitted or received over a communications network 1426 using a transmission medium via the network interface device 1420 and utilizing any one of a number of well-known transfer protocols (e.g., HTTP). Examples of communication networks 1426 include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 1424 for execution by the machine 1400, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

### EXAMPLES

Example 1 is a method facilitating a messaging session using a chatbot for lead generation. The method comprises establishing, by a networked system, a messaging session between the networked system and a user device of a user; requesting, by the networked system, submission of an address via the messaging session; receiving the address from the user device via the messaging session; verifying, by the networked system, the address received via the messaging session; based on verifying the address, generating, by the networked system, a report for the verified address, the report providing an estimated value for the verified address; and causing presentation of a user interface illustrating the generated report.

In example 2, the subject matter of example 1 can optionally include determining, from the messaging session, a contact number corresponding to the user device; associating the contact number with the messaging session; and storing the contact number and the association in a data storage.

In example 3, the subject matter of examples 1-2 can optionally include wherein the verifying comprises parsing the address from text of the messaging session; and determining a standardized version of the address.

In example 4, the subject matter of examples 1-3 can optionally include wherein the verifying further comprises returning the standardized version of the address via the messaging session; and receiving a verification that the standardized version of the address is correct.

In example 5, the subject matter of examples 1-4 can optionally include wherein the verifying further comprises returning the standardized version of the address via the messaging session; receiving an indication that the standardized version of the address is incorrect; and in response to receiving the indication, requesting reentry of the address.

In example 6, the subject matter of examples 1-5 can optionally include wherein the verifying further comprises receiving the reentry of the address; returning the standardized version of the reentered address via the messaging session; receiving an indication that the standardized version of the reentered address is still incorrect; and in response to receiving the indication that the standardized version of the reentered address is still incorrect, providing a uniform resource locator (URL) to a website of the networked system to continue verification of the address.

In example 7, the subject matter of examples 1-6 can optionally include wherein the generating the report comprises based on the verified address, accessing a database of properties and values; determining properties that are similar to the verified address; determining the estimated value based on values of the similar properties; and generating the user interface illustrating the generated report.

In example 8, the subject matter of examples 1-7 can optionally include wherein the causing presentation of the user interface comprises generating a custom uniform resource locator (URL) for the generated report for the verified address; and transmitting the custom URL via the messaging session to the user device.

In example 9, the subject matter of examples 1-8 can optionally include continuing the messaging session to obtain details about a property at the verified address; and refining the generated report based on the details.

In example 10, the subject matter of examples 1-9 can optionally include determining an intent of the user at the user device from the messaging session; based on the intent, determining to provide an offer for a property at the verified address; and in response to the determining to provide the offer, providing the offer via the messaging session.

In example 11, the subject matter of examples 1-10 can optionally include determining an intent of the user at the user device from the messaging session; based on the intent, determining not to provide an offer for the property at the verified address; and using the stored contact number for the user device, transmitting a follow up message at a later time.

Example 12 is a system for facilitating a messaging session using a chatbot for lead generation. The system includes one or more processors and a storage device storing instructions that, when executed by the one or more hardware processors, causes the one or more hardware processors to perform operations comprising establishing a messaging session between the networked system and a user device of a user; requesting submission of an address via the messaging session; receiving the address from the user device via the messaging session; verifying the address received via the messaging session; based on the verifying address, generating a report for the verified address, the report providing an estimated value for the verified address; and causing presentation of a user interface illustrating the generated report.

In example 13, the subject matter of example 12 can optionally include determining, from the messaging system, a contact number corresponding to the user device; associating the contact number with the messaging session; and storing the contact number and the association in a data storage.

In example 14, the subject matter of examples 12-13 can optionally include wherein the verifying comprises parsing the address from text of the messaging session; and determining a standardized version of the address.

In example 15, the subject matter of examples 12-14 can optionally include wherein the verifying further comprises returning the standardized version of the address via the messaging session; and receiving a verification that the standardized version of the address is correct.

In example 16, the subject matter of examples 12-15 can optionally include wherein the verifying further comprises returning the standardized version of the address via the messaging session; receiving an indication that the standardized version of the address is incorrect; and in response to receiving the indication, requesting reentry of the address.

In example 17, the subject matter of examples 12-16 can optionally include wherein the verifying further comprises receiving the reentry of the address; returning the standardized version of the reentered address via the messaging session; receiving an indication that the standardized version of the reentered address is still incorrect; and in response to receiving the indication that the standardized version of the reentered address is still incorrect, providing a uniform resource locator (URL) to a website of the networked system to continue verification of the address.

In example 18, the subject matter of examples 12-17 can optionally include wherein the generating the report comprises based on the verified address, accessing a database of properties and values; determining properties that are similar to the verified address; determining the estimated value based on values of the similar properties; and generating the user interface illustrating the generated report.

In example 19, the subject matter of examples 12-18 can optionally include wherein the causing presentation of the user interface comprises generating a custom uniform resource locator (URL) for the generated report for the verified address; and transmitting the custom URL via the messaging session to the user device.

Example 20 is a machine-storage medium for facilitating a messaging session using a chatbot for lead generation. The machine-storage medium configures one or more processors to perform operations comprising establishing a messaging session between the networked system and a user device of a user; requesting submission of an address via the messaging session; receiving the address from the user device via the messaging session; verifying the address received via the messaging session; based on the verifying address, generating a report for the verified address, the report providing an estimated value for the verified address; and causing presentation of a user interface illustrating the generated report.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
establishing, by a networked system, a messaging session between the networked system and a user device of a user;
requesting, by the networked system, submission of an address via the messaging session;
receiving the address from the user device via the messaging session;
verifying, by the networked system, the address received via the messaging session;
based on verifying the address, generating, by the networked system, a report for the verified address, the report providing an estimated value for the verified address; and
causing presentation of a user interface illustrating the generated report.

2. The method of claim 1, further comprising:
determining, from the messaging session, a contact number corresponding to the user device;
associating the contact number with the messaging session; and
storing the contact number and the association in a data storage.

3. The method of claim 1, wherein the verifying comprises:
parsing the address from text of the messaging session; and
determining a standardized version of the address.

4. The method of claim 3, wherein the verifying further comprises:
returning the standardized version of the address via the messaging session; and
receiving a verification that the standardized version of the address is correct.

5. The method of claim 3, wherein the verifying further comprises:
returning the standardized version of the address via the messaging session;
receiving an indication that the standardized version of the address is incorrect; and
in response to receiving the indication, requesting reentry of the address.

6. The method of claim 5, wherein the verifying further comprises:
receiving the reentry of the address;
returning the standardized version of the reentered address via the messaging session;
receiving an indication that the standardized version of the reentered address is still incorrect; and
in response to receiving the indication that the standardized version of the reentered address is still incorrect, providing a uniform resource locator (URL) to a website of the networked system to continue verification of the address.

7. The method of claim 1, wherein the generating the report comprises:
based on the verified address, accessing a database of properties and values;
determining properties that are similar to the verified address;
determining the estimated value based on values of the similar properties; and
generating the user interface illustrating the generated report.

8. The method of claim 1, wherein the causing presentation of the user interface comprises:
generating a custom uniform resource locator (URL) for the generated report for the verified address; and
transmitting the custom URL via the messaging session to the user device.

9. The method of claim 1, further comprising:
continuing the messaging session to obtain details about a property at the verified address; and
refining the generated report based on the details.

10. The method of claim 1, further comprising:
determining an intent of the user at the user device from the messaging session;
based on the intent, determining to provide an offer for a property at the verified address; and
in response to the determining to provide the offer, providing the offer via the messaging session.

11. The method of claim 1, further comprising:
determining an intent of the user at the user device from the messaging session;
based on the intent, determining not to provide an offer for the property at the verified address; and
using the stored contact number for the user device, transmitting a follow up message at a later time.

12. A system comprising:
one or more hardware processors; and
a storage device storing instructions that, when executed by the one or more hardware processors, cause the one or more hardware processors to perform operations comprising:
establishing a messaging session between the networked system and a user device of a user;
requesting submission of an address via the messaging session;
receiving the address from the user device via the messaging session;
verifying the address received via the messaging session;
based on the verifying address, generating a report for the verified address, the report providing an estimated value for the verified address; and
causing presentation of a user interface illustrating the generated report.

13. The system of claim 12, wherein the operations further comprise:
determining, from the messaging system, a contact number corresponding to the user device;
associating the contact number with the messaging session; and
storing the contact number and the association in a data storage.

14. The system of claim 12, wherein the verifying comprises:
parsing the address from text of the messaging session; and
determining a standardized version of the address.

15. The system of claim 14, wherein the verifying further comprises:
returning the standardized version of the address via the messaging session; and
receiving a verification that the standardized version of the address is correct.

16. The system of claim 14, wherein the verifying further comprises:
returning the standardized version of the address via the messaging session;
receiving an indication that the standardized version of the address is incorrect; and
in response to receiving the indication, requesting reentry of the address.

17. The system of claim 16, wherein the verifying further comprises:
receiving the reentry of the address;
returning the standardized version of the reentered address via the messaging session;
receiving an indication that the standardized version of the reentered address is still incorrect; and
in response to receiving the indication that the standardized version of the reentered address is still incorrect, providing a uniform resource locator (URL) to a website of the networked system to continue verification of the address.

18. The system of claim 12, wherein the generating the report comprises:
based on the verified address, accessing a database of properties and values;
determining properties that are similar to the verified address;
determining the estimated value based on values of the similar properties; and
generating the user interface illustrating the generated report.

19. The system of claim 12, wherein the causing presentation of the user interface comprises:
generating a custom uniform resource locator (URL) for the generated report for the verified address; and
transmitting the custom URL via the messaging session to the user device.

20. A machine-storage medium storing instructions that, when executed by the one or more hardware processors of a machine, cause the machine to perform operations comprising:
establishing a messaging session between the networked system and a user device of a user;
requesting submission of an address via the messaging session;
receiving the address from the user device via the messaging session;
verifying the address received via the messaging session;
based on the verifying address, generating a report for the verified address, the report providing an estimated value for the verified address; and
causing presentation of a user interface illustrating the generated report.
